(19) United States
(12) Patent Application Publication
(10) Pub. No.: US 2008/0266326 A1
(43) Pub. Date: Oct. 30, 2008

(54) AUTOMATIC IMAGE REORIENTATION

(75) Inventor: Gunjan Porwal, Banjara Hills (IN)

Correspondence Address: ADVANCED MICRO DEVICES, INC.;C/O VEDDER PRICE P.C., 222 N.LASALLE STREET, CHICAGO, IL, 60601, US

(73) Assignee: ATI Technologies ULC, Markham (CA)

(21) Appl. No.: 11/739,896

(22) Filed: Apr. 25, 2007

(51) Int. Cl. G09G 5/00

(52) U.S. Cl. 345/659

(57) ABSTRACT

Method for automatic image reorientation is disclosed. In an embodiment, the method includes reorienting a displayed image in response to a change in relative orientation of a viewer image with respect to a reference image. The reorientation is performed to compensate, at least partially, for the change in relative orientation of the viewer image.

### FIELD OF THE INVENTION

The invention relates to devices with displays and specifically to reorientation of displayed image to facilitate better viewing experience.

### BACKGROUND

A large number of devices, for example PDAs, mobile phones, video players, etc. have associated displays. Users may prefer to use different orientations for the display, such as, portrait or landscape, for different applications. For example, a portrait orientation may be preferred for viewing a calendar. However, a landscape orientation may be preferred for viewing a movie or playing a game. A user may switch between the two orientations manually in existing systems. This may be done in a number of ways, for example, by sliding the display or by pressing a button etc.

### SUMMARY

A method for automatically reorienting a displayed image is disclosed. In an embodiment, the method includes reorienting the displayed image responsive to a change in relative orientation of a viewer image with respect to a reference image orientation. The displayed image is reoriented to at least partially compensate for the change in relative orientation of the viewer image.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different figures indicates similar or identical items.

FIG. 1 illustrates an exemplary system for automatic image reorientation in an implementation.

FIG. 2 illustrates portrait and landscape orientations of a displayed image according to an embodiment.

FIG. 3 illustrates landscape and portrait orientations of a displayed image according to another embodiment.

FIG. 4 illustrates an exemplary method for automatic image reorientation according to an implementation.

### DETAILED DESCRIPTION

Method and system for automatically reorienting a displayed image are disclosed. In an exemplary implementation, the method includes reorienting the displayed image to at least partially compensate for a change in relative orientation of a viewer image with respect to a reference image orientation. In contrast to existing systems, a viewer may view a displayed image in different orientations without providing an input manually. Moreover, the viewer can automatically view the displayed image in different orientations by rotating a display device relative to the viewer's face.

The following disclosure describes systems and methods for automatic image reorientation. While aspects of described systems and methods for automatic image reorientation can be implemented in any number of different computing systems, environments, and/or configurations, embodiments for automatic image reorientation are described in the context of the following exemplary system architecture(s) and method(s).

An Exemplary System:

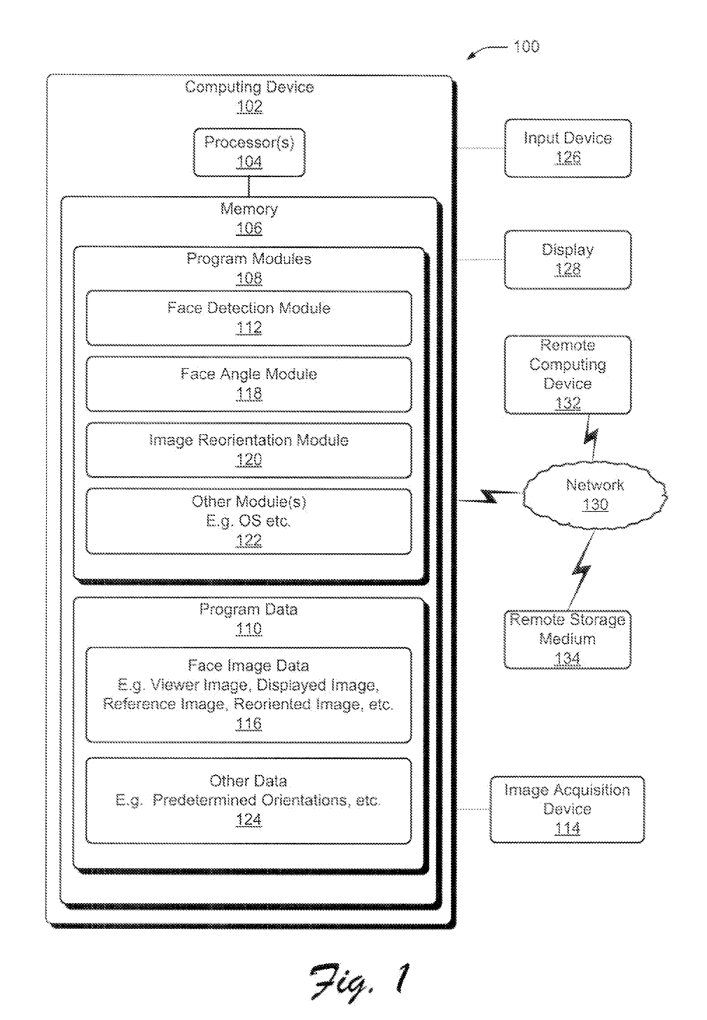

An exemplary system 100, describing one of the implementations for automatic image reorientation, is shown in FIG. 1. Accordingly, the system 100 includes a computing device 102 having one or more processor(s) 104 coupled to a memory 106. In an exemplary implementation, the computing device 102 may be a mobile phone, PDA, portable video player, etc. Processor(s) 104 includes, for example, microprocessors, microcomputers, microcontrollers, digital signal processors, central processing units, state machines, logic circuitries, and/or any devices that manipulate data based on operational instructions. The processors are configured to fetch and execute computer-program instructions stored in the memory 106. Such memory 106 includes, for example, one or more volatile memory (e.g., RAM) and non-volatile memory (e.g., ROM, Flash etc.).

The memory 106 stores computer executable instructions and data for automatic reorientation of a displayed image. For the purpose of ongoing description, displayed image may include digital images from a video stream, digital images representing pictures, screen savers, background or foreground of a scene and the like. In the exemplary system 100, the memory 106 includes program modules 108 and program data 110. Processor 104 fetches and executes computer program instructions from respective ones of the program modules 108. Program modules 108 include instructions to perform automatic image reorientation.

Accordingly, the program modules 108 include a face detection module 112 configured to detect a viewer image of a viewer. For purposes of exemplary illustration, viewer image includes an image of the face of the viewer. However, as will be appreciated by those of ordinary skill in the art, viewer image could be an image of another aspect of the viewer, for example, the viewer's full or partial silhouette, hand, profile view or the like. In the exemplary implementation, the program modules 108 also include other module(s) 122. The other module(s) 122 may include various modules required for the functioning of the computing device 102 such as an operating system, application software, etc.

In an implementation, the face detection module 112, when executed, invokes image acquisition device 114, to acquire the viewer image. The image acquisition device 114 may include devices such as, a camera or a scanner. Such a camera may be integrated with the computing device 102 or may be connected to the computing device 102. The image acquisition device 114, such as a camera, is common in devices, for example, mobile phones, etc. For instance, the Sony Ericsson K300i manufactured by Sony Ericsson having its headquarters at Hammersmith, London, has an in built camera. Similarly, the Nokia N70 manufactured by Nokia having its headquarters at Espoo, Finland, has an inbuilt camera. The face detection module 112 receives the viewer image and stores it in face image data 116 included in program data 110.

The viewer image may also include foreground objects, background objects, one or more faces in addition to the viewer's face. Therefore, it may be necessary to detect the viewer's face from the viewer image for determining the relative orientation of the viewer image. A human face also enables easy determination of relative orientation by face recognition methods known in the art. In such an implementation, the face detection module 112 detects the viewer's face from the viewer image employing face recognition methods.

Well-known face recognition methods are employed by many portable devices, for example, mobile phones, etc. having front cameras or scanners to acquire the face image of the viewer. Such devices may be configured to identify and authenticate the viewer. By way of example, the mobile phone 904SH from Vodafone, which has a built-in camera, uses face recognition methods to authenticate the viewer and unlock the device. Such face recognition methods may include, for example, segmentation i.e., selecting the regions (region of interest) of possible faces in the acquired viewer image. The results of the segmentation may further be refined by color specific selection and enforcing an aspect ratio on the regions of interest.

A face angle module 118 enables the computing device 102 to learn about any change in relative orientation of the viewer image stored in face image data 116. In an embodiment, the face angle module 118 may be configured to determine an angle measure of the change in the relative orientation of the viewer image. For purposes of exemplary illustration, relative orientation refers to an angle measured between two images, both of which are characterized by certain key features or nodal points. In one of the embodiments, the key features may be the nodal points defined on the face, like the eyes, nose, etc. or may include a neural network of nodes that may be defined by known face recognition techniques. To this end, the change in relative orientation of the viewer image may be determined with respect to a reference image orientation. The reference image includes any digital image, which may be utilized for determining relative orientation of the viewer image for exemplary purpose of illustration. The orientation of such an image has been referred to as reference image orientation in the description. It may be appreciated that a digital image may be characterized by its orientation.

In one implementation, the reference image orientation may be the orientation of viewer image last captured by the image acquisition device 114. For example, when a viewer activates a mobile device embodying the computing device 102, the image acquisition device 114 may be invoked by the face detection module 112 to capture an image of the viewer. Accordingly, the face angle module 118 may utilize the captured viewer image as the reference image for detecting a change in the relative orientation of subsequent viewer images.

In an alternate embodiment, the reference image may be selected and configured by a viewer. It may also be noted that certain devices may have stored images as a part of the software embedded therein. In such devices, manufacturer may define one particular image as a reference image. Furthermore, devices with inbuilt cameras may have a predefined reference image orientation by virtue of the mechanical disposition of the camera. It may be appreciated that any of the methods known in the art may be employed for determining relative orientation of an image and any change thereof. In another implementation, the face angle module 118 detects a change in relative orientation of the displayed image with respect to the viewer image orientation.

In the exemplary implementation, an image reorientation module 120 performs automatic image reorientation of the displayed image responsive to the change in relative orientation of the viewer image. To this end, the image reorientation module 120 may be configured to reorient the displayed image to at least partially compensate for any change detected by the face angle module 118. The reoriented image is stored in the face image data 116. Reoriented image includes a displayed image that has undergone reorientation according to the described methods of automatic image reorientation. It may be appreciated that the image reorientation module 120 uses image-processing methods known in the art to carry out the image reorientation. In one of the embodiments, the reorientation may be carried out automatically by the image reorientation module 120 to partially compensate for a change in relative orientation of the displayed image with respect to the viewer image.

In another configuration, the viewer may be prompted to provide an input in response to the change in the relative orientation of the viewer image. In such a configuration, the viewer may provide an input to the computing device by an input device 126. The input device, in alternate embodiments, may include, for example, one or more of a mouse, a keyboard, a joystick, a keypad, a touch screen or any other device, which may be used for providing such input to the computing device 102.

In another implementation, the image reorientation module 120 may select one of the predetermined orientations stored in other data 124, for the displayed image. Such selection may be performed in response to the change in relative orientation of the viewer image with respect to the reference image orientation. The image reorientation module 120 may reorient the displayed image in accordance with the selected predetermined orientation. In yet another implementation, the selection of the predetermined orientation may be performed to at least partially compensate for the change in relative orientation of the viewer image. In the example cited above, the four predetermined orientations of the displayed image correspond to 0 degrees, 90 degrees clockwise and anticlockwise and 180 degrees with respect to the reference image orientation. Therefore, depending upon a magnitude of angle measure of the relative orientation of the viewer image, one of the four predetermined orientations may be selected. In yet another implementation, the image reorientation module 120 may be configured to switch between the predetermined orientations.

Such predetermined orientations may include, for example, landscape orientation and portrait orientation of the displayed image with respect to the reference image orientation. It may be appreciated that there may be four orientations, two of which may be landscape and two may be portrait. The displayed image and the reoriented image stored in face image data 116 may be viewed on a display 128 associated with the computing device 102. In one embodiment, the display 128 includes for example, VGA (Video Graphics Array) screen, mobile display screens, PDA displays etc.

In another embodiment of the system 100, the computing device 102 may communicate through a network 130, with one or more remote computing device 132. The network 130 may include, for example, LAN, WAN, MAN, Wireless Network, Optical Network, etc. The remote computing device 132 may include, for example, a personal computer, a mobile phone, a PDA, etc. In an alternate embodiment, the computing device 102 may be connected to a remote storage medium 134 through the network 130. The displayed image may be retrieved, in such an embodiment, from the remote storage medium 134 or from the remote computing device 132. The system 100, in an alternate embodiment, may include an interface to facilitate connections with image sources like a DVD player, a VCD player, an iPod, and the like. In such an embodiment, video files may be displayed on the display 128 and the computing device 102 may perform automatic image reorientation on images corresponding to such video files.

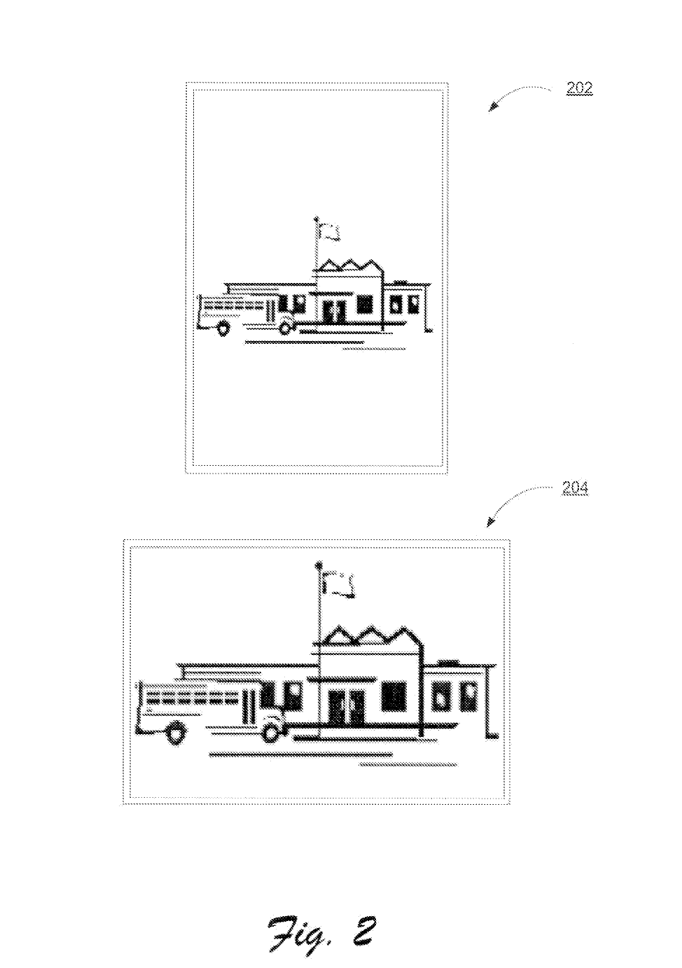

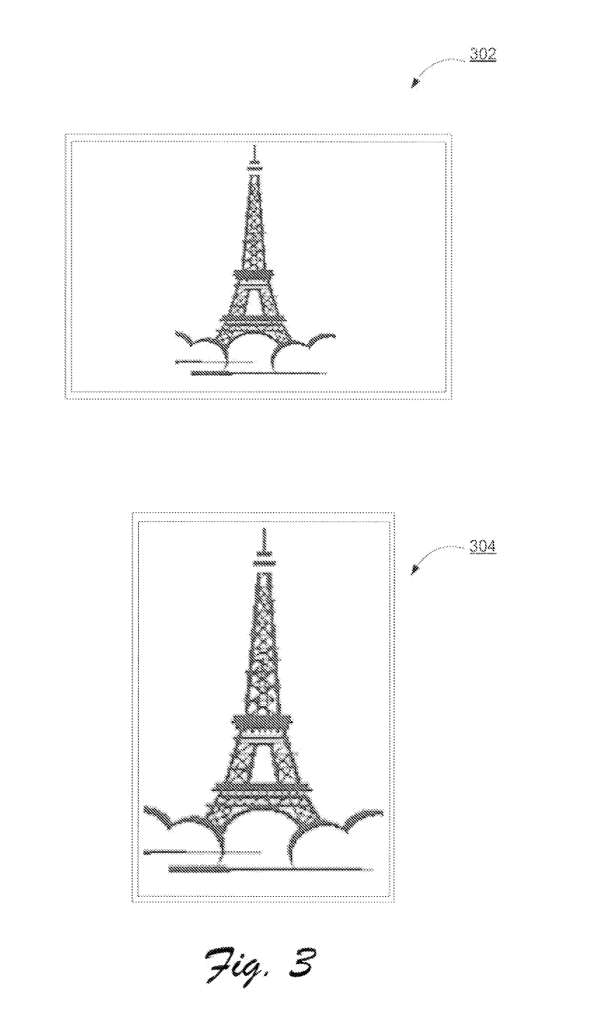

In a typical scenario, the displayed image may be reoriented based on a selected predetermined orientation. Accordingly, FIG. 2 and FIG. 3 illustrate landscape orientation and portrait orientation for two different displayed images respectively. Two more orientations are possible by reversing the two orientations shown in FIG. 2 and FIG. 3. For example, the displayed image may be presented in a portrait orientation 202, as shown in FIG. 2. The viewer may wish to view the image in a landscape orientation. This may be possible by simply rotating the display 128 with respect to the viewer's face. Such rotation results in a change in the relative orientation of the viewer image. Accordingly, the face angle module 118 determines the angle measure of the change in the relative orientation of the viewer image. If the magnitude of the angle measure is between 45 degrees and 135 degrees clockwise, the displayed image may be reoriented by the image reorientation module 120 to landscape orientation 204. This may be accomplished by reorienting the displayed image by 90 degrees anticlockwise.

In another example, if the magnitude of angle measure is between 225 degrees and 315 degrees clockwise, which is the same as between 45 degrees and 135 degrees anticlockwise, the displayed image may be reoriented by 90 degrees clockwise. By way of example, if the magnitude of difference is between 135 degrees and 225 degrees, the displayed image may be reoriented by 180 degrees. Such an exemplary computing device 102 enables the viewer of the displayed image on a mobile device, to switch between portrait and landscape orientations 202 and 204 by physically turning the display 128 while viewing the displayed image.

FIG. 3 shows an example where the viewer may wish to switch from a landscape orientation 302 to a portrait orientation 304. Accordingly, the viewer may rotate the display 128 by 90 degrees clock wise or anti clockwise. The face detection module 112 acquires the viewer image and the face angle module 118 detects a change in relative orientation of the viewer image. The image reorientation module 120 reorients the displayed image by selecting a predetermined orientation of the displayed image. For example, the displayed image may be reoriented 90 degrees anti clockwise if the device was rotated clockwise and 90 degrees clockwise if the device was rotated anti clockwise. It may be appreciated that both the reorientations result in a portrait orientation.

An Exemplary Method:

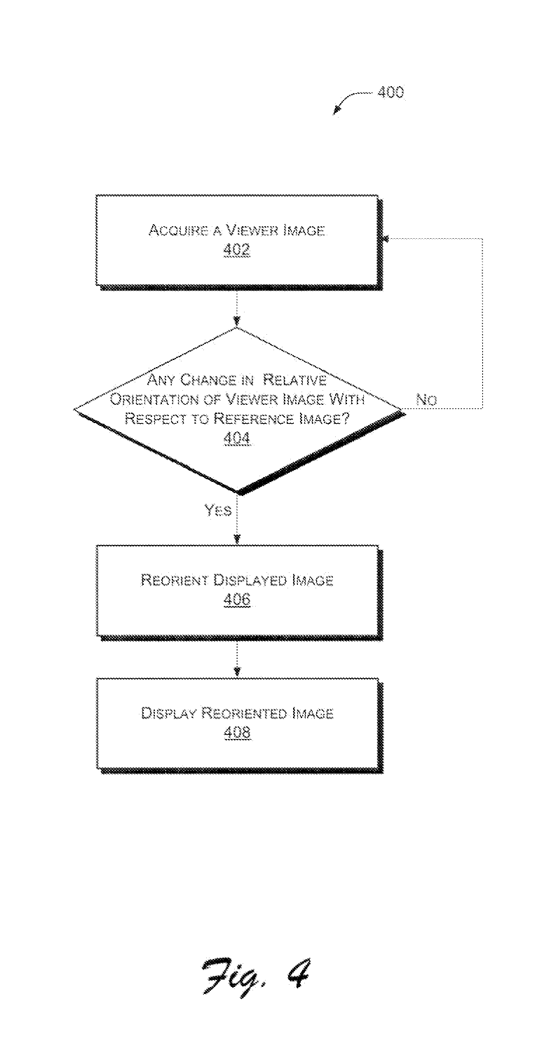

Methods for automatic image reorientation, such as exemplary method 400 that is described in FIG. 4, may be described in the general context of computer executable instructions. Generally, computer executable instructions can include routines, programs, objects, components, data structures, procedures, modules, functions, and the like that perform particular functions or implement particular abstract data types.

FIG. 4, illustrating an exemplary method 400 for automatic image reorientation of a displayed image, is described with reference to the exemplary system 100. The order in which the method is described is not intended to be construed as a limitation, and any number of the described method blocks can be combined in any order to implement the method, or an alternate method.

At block 402, a viewer image is acquired. In an exemplary implementation, the viewer image may be acquired by the image acquisition device 114 invoked by the face detection module 112. The acquired image is stored in the face image data 116.

At block 404, any change in relative orientation of the viewer image with respect to a reference image orientation is detected. In an implementation, the face angle module 118 determines whether there is a change in the relative orientation of the acquired viewer image. The reference image orientation may correspond to an orientation of a previously stored image. In an alternate embodiment, the previously stored image may be configured by the viewer. For example, the viewer may select any image of choice and configure the computing device 102 to utilize such image as the reference image. If no change in relative orientation is detected, the computing device 102 may be configured to continue acquiring viewer image until the face detection module 112 detects a change.

At block 406, responsive to the change detected at block 404, the displayed image is reoriented to at least partially compensate for the change. In the exemplary embodiment, the image reorientation module 120 reorients the displayed image stored in the face image data 116 responsive to a change in the relative orientation of the viewer image. The resulting reoriented image gets stored in face image data 116. In another embodiment, reorientation may include switching between a plurality of predetermined orientations of the displayed image relative to the reference image orientation.

In one of the implementations, the image reorientation module 120 prompts the viewer for an input in response to the change detected at block 404. The viewer, in such an implementation, provides an input through the input device 126. For example, a message may be prompted to the viewer indicating that a change in the relative orientation of the viewer has been detected. The viewer may provide input with regard to the reorientation of the displayed image thereafter.

In yet another embodiment, the reorientation of the displayed image may be performed in response to a change in relative orientation of the displayed image with respect to the viewer image. In such an embodiment, the reorientation results in at least partial compensation of the change in relative orientation of the displayed image.

In yet another configuration, the reorientation of the displayed image includes selecting one of predetermined orientations. To this end, the image reorientation module 120 selects one of the predetermined orientations for the displayed image in response to the change detected at block 404. Further, the displayed image may be reoriented by the image reorientation module 120 based on the selected predetermined orientation.

At block 408, the reoriented image is displayed. In an implementation, the image reorientation module 120 retrieves the reoriented image and presents it to the display 128 for viewing. The system 100 may be configured to detect any further change to relative orientation of the viewer image during operation of the computing device 102. In one implementation, this is done periodically after a predetermined time interval, for example, 2 seconds, etc.

### CONCLUSION

Although embodiments of automatic image reorientation have been described in language specific to structural features and/or methods, it is to be understood that the appended claims are not necessarily limited to the specific features or methods described. Rather, the specific features and methods are disclosed as exemplary implementations of automatic image reorientation.

I/we claim:

1. A method of reorienting a displayed image comprising:
responsive to a change in relative orientation of a viewer image with respect to a reference image orientation, reorienting the displayed image to at least partially compensate for said change in relative orientation.

2. The method of claim 1 further comprises acquiring the viewer image.

3. The method of claim 1, wherein the reference image orientation corresponds to an orientation of a previously stored image.

4. The method of claim 1, wherein the reference image orientation corresponds to an orientation of a previously stored image configurable by a viewer.

5. The method of claim 1, wherein reorienting further comprises switching between a plurality of predetermined orientations.

6. The method of claim 5, wherein the predetermined orientations comprises landscape and portrait orientations of the displayed image with respect to the reference image orientation.

7. The method of claim 1, wherein reorienting is performed on receiving an input from a viewer.

8. A system comprising at least one display, one or more processors and a memory coupled to the processor(s), the memory comprising computer-programmable instructions executable by the processor for:
responsive to a change in relative orientation of a displayed image with respect to a viewer image orientation, reorienting the displayed image to at least partially compensate for the change in relative orientation, the viewer image orientation being relative to a reference image orientation.

9. The system of claim 8 further comprising a camera for acquiring the viewer image from a camera associated with the system.

10. The system of claim 8, wherein the reference image orientation corresponds to an orientation of a previously stored image.

11. The system of claim 8, wherein the reference image orientation corresponds to an orientation of a previously stored image configurable by a viewer.

12. The system of claim 8, wherein reorienting further comprises:
selecting one of plurality of predetermined orientations; and
orienting the displayed image based on the selection.

13. The system of claim 12, wherein the predetermined orientations comprises landscape and portrait orientations of the displayed image with respect to the reference image orientation.

14. The system of claim 8, wherein reorienting is performed on receiving an input from a viewer.

15. One or more computer readable media comprising computer executable instructions that, when executed, direct a computing based device to perform acts comprising:
responsive to a change in relative orientation of a viewer image with respect to a reference image orientation, selecting one of plurality of predetermined orientations; and
reorienting a displayed image based on the selected predetermined orientation.

16. The one or more computer readable media of claim 15 further comprising instructions for acquiring the viewer image.

17. The one or more computer readable media of claim 15, wherein the viewer image comprises aspects of viewer's face.

18. The one or more computer readable media of claim 15, wherein the reference image orientation corresponds to an orientation of a previously stored viewer image configurable by a viewer.

19. The one or more computer readable media of claim 15, wherein the plurality of predetermined orientations comprises landscape and portrait orientations of the displayed image with respect to the reference image orientation.

20. The one or more computer readable media of claim 15, wherein reorienting is performed on receiving an input from a viewer.
